(19) United States
(12) Patent Application Publication
(10) Pub. No.: US 2026/0166803 A1
(43) Pub. Date: Jun. 18, 2026

(54) BENT-NECK CONTAINER MANUFACTURING DEVICE, AND BENT-NECK CONTAINER MANUFACTURING METHOD

(71) Applicant: NISSEI ASB MACHINE CO., LTD., Nagano (JP)

(72) Inventors: Ryo Minemura, Nagano (JP); Naoyuki Takada, Nagano (JP)

(21) Appl. No.: 19/126,622

(22) PCT Filed: Nov. 2, 2023
(86) PCT No.: PCT/JP2023/039690

§ 371 Date: May 16, 2025

(30) Foreign Application Priority Data
Nov. 4, 2022 (JP) 2022-177505

(51) Int. Cl. B29C 49/48; B29C 45/33; B29C 49/06; B29C 49/36; B29C 49/46

(52) U.S. Cl. CPC B29C 49/48; B29C 45/33; B29C 49/06; B29C 49/36; B29C 49/46

(57) ABSTRACT

A blow molding unit (130) includes a neck mold (131), a blow core (132), a rotation mechanism (134), and a blow mold. The neck mold (131) holds the neck portion (21) forming an opening of a preform (20) from an outer circumference. The blow core (132) is configured to introduce blow air into the preform (20). The rotation mechanism (134) bends the preform (20) at a predetermined angle while gripping a bottom portion of the preform (20) in a state where the blow core 132(132 ) is inserted in the opening of the preform (20). The blow mold defines a blow cavity to accommodate the bent preform (20). A lower end portion (132a) of the blow core (132) is configured to be disposed below a bottom surface (131a) of the neck mold (131) in a state where the blow core (132) is inserted in the preform (20).

### TECHNICAL FIELD

The disclosure relates to a manufacturing apparatus for manufacturing a bent-neck container and a manufacturing method for manufacturing a bent-neck container.

### BACKGROUND ART

Patent Document 1 discloses a manufacturing method for manufacturing a bent-neck container. Patent Document 2 discloses a technique for improving an appearance of a bent-neck container. Further, Patent Document 3 discloses a manufacturing method in which a blow core is inserted in a preform and blow molding is performed.

### Citation List

### Patent Literature

Patent Document 1: WO 2020/017505
Patent Document 2: JP 2006-062110 A
Patent Document 3: JP H06-047269 B

### SUMMARY OF INVENTION

### Technical Problem

In a case in which a bent-neck container including a body portion having a high degree of inclination relative to a neck portion is manufactured, a step of bending the body portion of the preform is required prior to introducing blow air. In the method described above, it is not possible to adjust a bending part of the body portion of the preform. When the body portion near the neck portion bends, a visible wrinkle (horizontally elongated depression) may form in an outer surface of the body portion near the neck portion of the bent-neck container, leaving room for improvement.

An object of the disclosure is to provide a manufacturing apparatus for manufacturing a bent-neck container and a manufacturing method for manufacturing a bent-neck container that further improve an appearance of a bent-neck container.

### Solution to Problem

A manufacturing apparatus for manufacturing a bent-neck container according to an aspect of the disclosure is a manufacturing apparatus for manufacturing a bent-neck container from a preform having a bottomed tubular shape by blow molding. The manufacturing apparatus includes an injection molding unit configured to injection-mold the preform made of resin, a blow molding unit configured to blow-mold the preform to manufacture the bent-neck container, a neck mold configured to hold a neck portion forming an opening of the preform from an outer circumference of the neck portion, and a transport mechanism configured to transport the neck mold from the injection molding unit to the blow molding unit. The blow molding unit includes a blow core configured to introduce blow air into the preform, a rotation mechanism configured to bend the preform at a predetermined angle while gripping a bottom portion of the preform in a state where the blow core is inserted in the opening of the preform, and a blow mold configured to define a blow cavity to accommodate the preform that is bent. A lower end portion of the blow core is configured to be disposed below a bottom surface of the neck mold in a state where the blow core is inserted in the preform.

A manufacturing apparatus for manufacturing a bent-neck container according to an aspect of the disclosure is a manufacturing apparatus for manufacturing a bent-neck container from a preform having a bottomed tubular shape by blow molding. The manufacturing apparatus includes an injection molding unit configured to injection-mold the preform made of resin, a blow molding unit configured to blow-mold the preform to manufacture the bent-neck container, a neck mold configured to hold a neck portion forming an opening of the preform from an outer circumference of the neck portion, and a transport mechanism configured to transport the neck mold from the injection molding unit to the blow molding unit. The blow molding unit includes a rotation mechanism configured to grip a bottom portion of the preform and bend the preform at a predetermined angle, and a blow mold configured to form a blow cavity to accommodate the preform that is bent. The injection molding unit includes an injection molding mold configured to define an injection cavity in which the preform is formed. The injection molding mold is configured to form, in a body portion of the preform in which a side surface of the bent-neck container is to be formed, a thick portion at a portion adjacent to the neck portion forming the opening of the preform, the thick portion being thicker than other parts of the body portion. The rotation mechanism is configured to bend the preform at a side where the thick portion is formed.

A manufacturing method for manufacturing a bent-neck container according to an aspect of the disclosure is a manufacturing method for manufacturing a bent-neck container from a preform having a bottomed tubular shape by blow molding. The manufacturing method includes an injection molding step of injection-molding the preform made of resin, and a blow molding step of blow-molding the preform in a state where a neck portion forming an opening of the preform is held from an outer circumference by the neck mold to manufacture the bent-neck container. The blow molding step includes introducing blow air into the preform, by using a blow core, bending the preform at a predetermined angle in a state where the blow core is inserted in the opening of the preform while gripping a bottom portion of the preform, by using a rotation mechanism, and defining a blow cavity to accommodate the preform that is bent, by using a blow mold. The preform is bent by the rotation mechanism starting from a lower end portion of the blow core.

A manufacturing method for manufacturing a bent-neck container according to an aspect of the disclosure is a manufacturing method for manufacturing a bent-neck container from a preform having a bottomed tubular shape by blow molding. The manufacturing method includes an injection molding step of injection-molding the preform made of resin, and a blow molding step of blow-molding the preform in a state where a neck portion forming an opening of the preform is held from an outer circumference by the neck mold to manufacture the bent-neck container. The blow molding step includes gripping a bottom portion of the preform and bending the preform at a predetermined angle, by using a rotation mechanism, and defining a blow cavity to accommodate the preform that is bent, by using a blow mold. The injection molding step includes defining an injection cavity in which the preform is formed by using an injection molding mold. The injection molding mold is configured to form, in a body portion of the preform in which a side surface of the bent-neck container is formed, a thick portion at a portion adjacent to the neck portion forming the opening of the preform, the thick portion being thicker than other parts of the body portion. The rotation mechanism is configured to bend the preform at a side where the thick portion is formed.

### Advantageous Effects of Invention

According to the disclosure, it is possible to provide a manufacturing apparatus and a manufacturing method for manufacturing a bent-neck container that further improve an appearance of a bent-neck container.

### BRIEF DESCRIPTION OF DRAWINGS

FIG. 1A is a left side view of a bent-neck container manufactured by a manufacturing apparatus of a first embodiment.

FIG. 1B is a front view of the bent-neck container manufactured by the manufacturing apparatus of the first embodiment.

FIG. 2 is a block diagram of the manufacturing apparatus for manufacturing the bent-neck container in the first embodiment.

FIG. 3 illustrates a preform manufactured by an injection molding unit.

FIG. 4 illustrates a blow molding unit according to the present embodiment.

FIG. 5 illustrates the blow molding unit according to the present embodiment.

FIG. 6 illustrates the blow molding unit according to the present embodiment.

FIG. 7 is a sectional view taken in the direction of arrow VII in FIG. 6.

FIG. 8 illustrates a blow molding unit 130A according to a comparative example.

FIG. 9 illustrates the injection molding unit according to a second embodiment.

FIG. 10 illustrates a blow molding unit according to the second embodiment.

### DESCRIPTION OF EMBODIMENTS

Hereinafter, as an embodiment of the disclosure, a manufacturing apparatus 100 and a manufacturing method for manufacturing a bent-neck container 10 will be described with reference to the drawings. The dimensions of each member illustrated in the drawings may differ from the actual dimensions of each member for convenience of description.

Further, for convenience of description, reference will be made to an “up-down direction,” a “front-back direction,” and a “left-right direction” as appropriate. Here, the “up-down direction” is a direction including an “upward direction” and a “downward direction.” The “front-back direction” is a direction including a “frontward direction” and a “backward direction.” The “left-right direction” is a direction including a “leftward direction” and a “rightward direction.” A reference sign U illustrated in the drawings described below denotes the upward direction. A reference sign D denotes the downward direction. A reference sign F denotes the frontward direction. A reference sign B denotes the backward direction. A reference sign L denotes the leftward direction. A reference sign R denotes the rightward direction. Further, a “horizontal surface” indicates a surface orthogonal to the up-down direction. A “horizontal cross section” indicates a cross section orthogonal to the up-down direction.

### First Embodiment

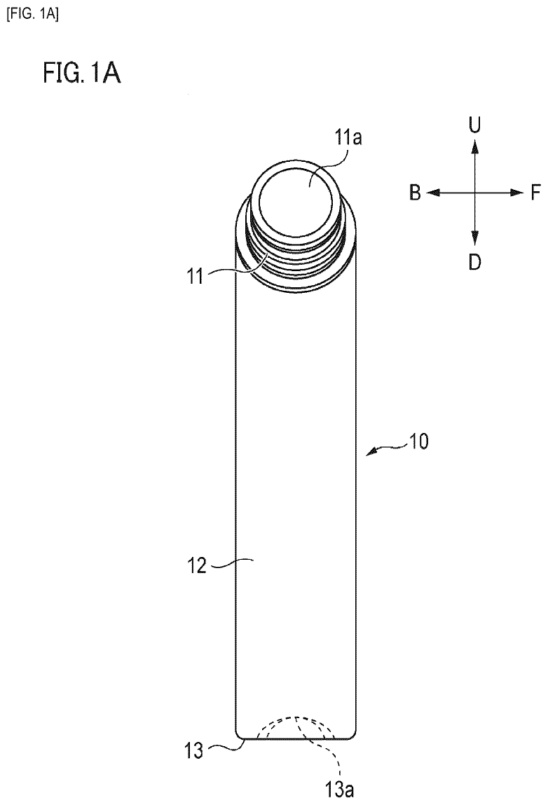

The manufacturing apparatus 100 and the manufacturing method for manufacturing the bent-neck container 10 according to a first embodiment will now be described. FIGS. 1A and 1B illustrate the bent-neck container 10 manufactured by the manufacturing apparatus 100 of the present embodiment. Note that FIG. 1A is a left side view of the bent-neck container 10. FIG. 1B is a front view of the bent-neck container 10. The bent-neck container 10 includes a container mouth portion 11, a container body portion 12, and a container bottom portion 13. An opening portion 11a is formed in the container mouth portion 11. The container body portion 12 is connected to the container mouth portion 11, defining a side wall surface of the bent-neck container 10. The container bottom portion 13 is formed connected to the container body portion 12. The container bottom portion 13 is provided with an outer edge portion that makes contact with a horizontal surface and an upper bottom portion 13a recessed toward the container body portion 12.

An axis A of the opening portion 11a provided in the container mouth portion 11 is inclined relative to an axis B of the container bottom portion 13 extending vertically from a center of the container bottom portion 13. Note that the axis A is a line that passes through a center of the opening portion 11a and extends at a right angle to an upper end surface of the opening portion 11a. An angle formed by the axis A and the axis B is defined as an inclination angle θ. The range of the inclination angle θ is, for example, 40°≤θ≤70°.

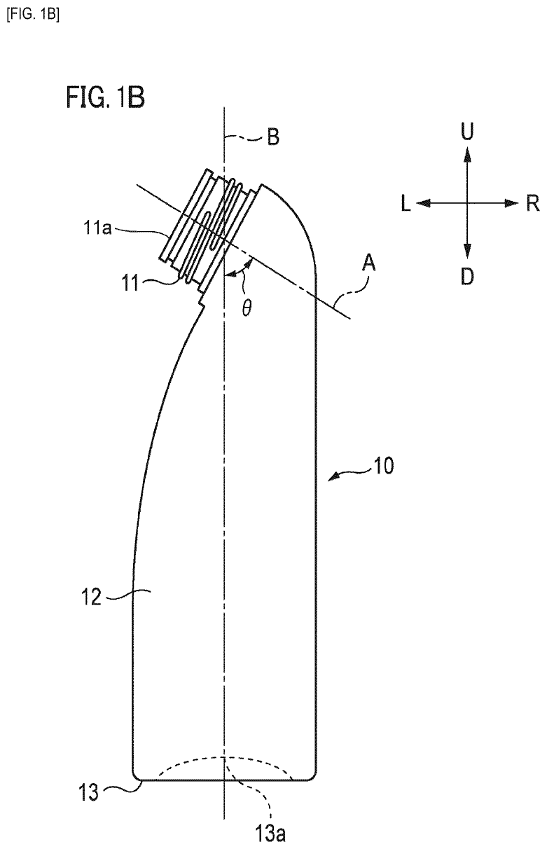

FIG. 2 is a block diagram of the manufacturing apparatus 100 for manufacturing the bent-neck container 10. As illustrated in FIG. 2, the manufacturing apparatus 100 includes an injection molding unit 110, a temperature adjustment unit 120, a blow molding unit 130, a take-out unit 140, and a transport means (transport mechanism) 150.

The injection molding unit 110 manufactures a preform 20 made of resin by performing injection molding by using an injection device. A synthetic resin that serves as raw material for the preform 20 is a thermoplastic resin, and may be selected as appropriate in accordance with the application. Examples of the thermoplastic resin include polypropylene (PP), polyethylene (PE), polyethylene terephthalate (PET), polycarbonate (PC), and polyethylene naphthalate (PEN).

The temperature adjustment unit 120 adjusts a temperature of the preform 20 manufactured by the injection molding unit 110 to a temperature suitable for blow molding.

The blow molding unit 130 blow-molds the preform 20 adjusted in temperature by the temperature adjustment unit 120 to manufacture the bent-neck container 10.

The take-out unit 140 takes out the bent-neck container 10 manufactured by the blow molding unit 130.

The injection molding unit 110, the temperature adjustment unit 120, the blow molding unit 130, and the take-out unit 140 are provided at positions obtained by rotation by a predetermined angle about the transport means 150. In the present embodiment, the predetermined angle is 90 degrees. The transport means 150 includes a rotating plate (not illustrated). A neck mold 131 described below is attached to the rotating plate. The transport means 150 is configured such that the rotating plate rotates with the neck mold 131 holding the preform 20, thereby transporting the preform 20 to each of the injection molding unit 110, the temperature adjustment unit 120, the blow molding unit 130, and the take-out unit 140.

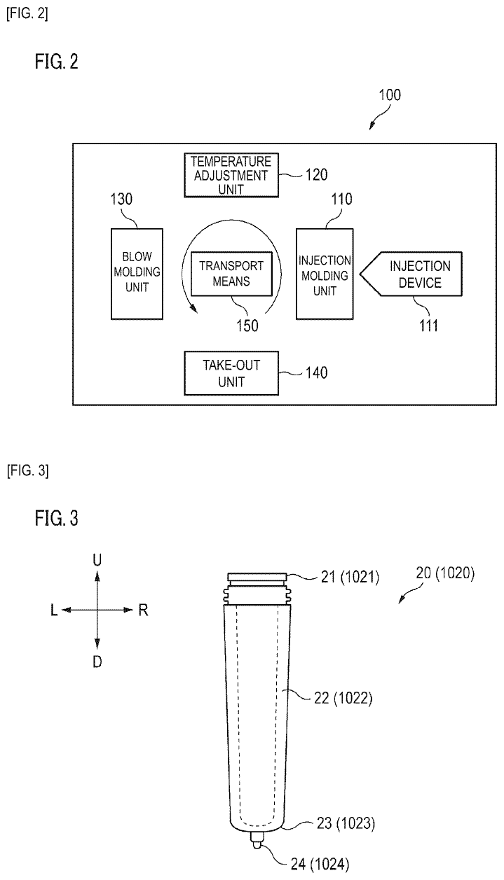

FIG. 3 illustrates the preform 20 manufactured by the injection molding unit 110. The preform 20 has a bottomed tubular shape. The preform 20 includes a neck portion 21, a body portion 22, and a bottom portion 23. The neck portion 21 forms an opening of the preform 20. The body portion 22 is continuously connected to the neck portion 21. The bottom portion 23 is continuously connected to the body portion 22 and configured to close one end portion of the preform 20. The bottom portion 23 includes a projecting portion 24. The projecting portion 24 is configured to be held by a rotation mechanism 134 described below.

When blow molding is performed, the preform 20 becomes the bent-neck container 10. When blow molding is performed, the neck portion 21 becomes the container mouth portion 11. The body portion 22 becomes the container body portion 12. The bottom portion 23 becomes the container bottom portion 13.

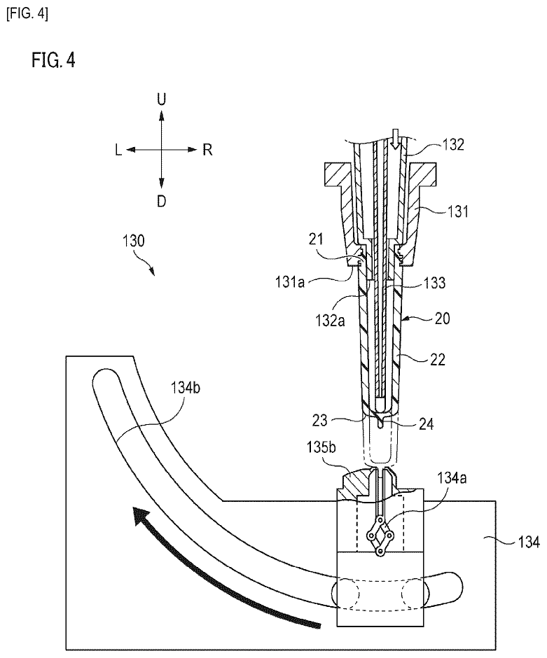

The blow molding unit 130 according to the present embodiment will be described with reference to FIGS. 4 to 6. FIGS. 4 to 6 illustrate the blow molding unit 130 according to the present embodiment. The blow molding unit 130 of the present embodiment is configured to perform stretch blow molding.

The neck mold 131 is configured to hold the neck portion 21 of the preform 20 from an outer circumference thereof. The neck mold 31 is cyclically and intermittently transported by the transport means 150 between the respective units including at least the injection molding unit 110 and the blow molding unit 130.

The blow molding unit 130 includes a blow core 132. The blow core 132 is configured to be inserted in the opening of the preform 20 and configured to introduce blow air into an interior of the preform 20. The blow air is a pressurized medium such as air. The blow core 132 is configured to come into contact with an inner surface of the preform 20 and form an air seal between the preform 20 and the blow core 132 when inserted in the opening. A part of the blow core 132 that is inserted in the preform 20 has a hollow cylindrical shape.

The blow molding unit 130 includes a stretch rod 133. The stretch rod 133 is provided in an interior of the blow core 132, and is configured to be displaceable in the up-down direction. The stretch rod 133 is configured to stretch the preform 20 by coming into contact with the bottom portion 23 of the preform 20 and displacing it downwardly. The stretching of the preform 20 by the stretch rod 133 may be referred to as vertical axis stretching (preliminary stretching).

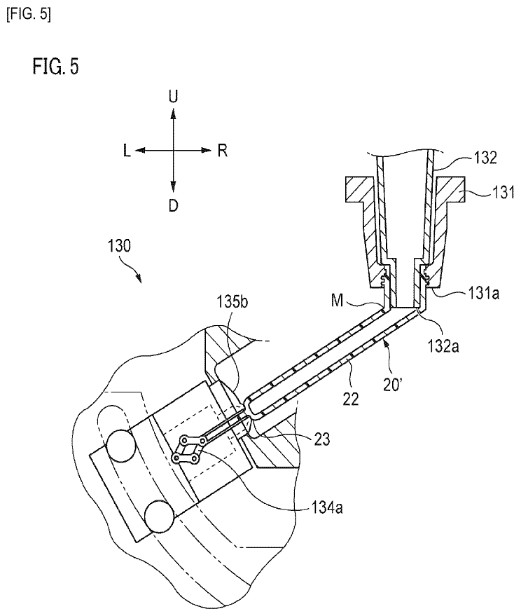

The blow molding unit 130 includes the rotation mechanism 134. As illustrated in FIG. 4, the rotation mechanism 134 includes a holding part 134a configured to hold the projecting portion 24 that is part of the bottom portion 23. As illustrated in FIG. 5, the rotation mechanism 134 is configured to bend the preform 20 at a predetermined angle. The rotation mechanism 134 includes a guide portion 134b. The guide portion 134b is formed so as to have an arc shape. The rotation mechanism 134 is configured to rotate the holding part 134a along the guide portion 134b.

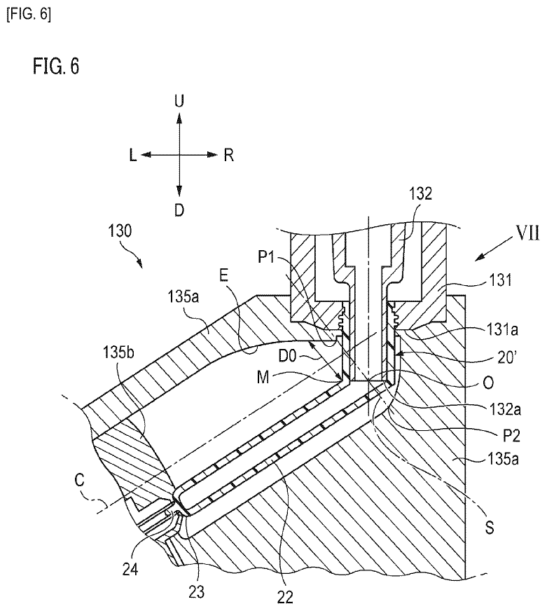

As illustrated in FIG. 6, the blow molding unit 130 includes a blow mold. The blow mold defines a blow cavity (molding space for container) so as to accommodate the preform 20 bent by the rotation mechanism 134. In the present embodiment, the blow mold includes a pair of split molds 135a and a bottom mold part 135b. The bottom mold part 135b is attached so as to cover the holding part 134a. The split molds 135a are closed in a state in which the preform 20 is bent at the predetermined angle by the rotation mechanism 134, forming the blow cavity. The pair of split molds 135a define a blow cavity corresponding to the container body portion 12 of the bent-neck container 10. The bottom mold part 135b defines a blow cavity corresponding to the container bottom portion 13 of the bent-neck container 10. Note that the rotation mechanism 134 may be provided in the blow mold (more specifically, a pair of blow mold fixing plates to which each of the pair of split molds 135a is fixed).

Next, a blow molding step will be described with reference to FIGS. 4 to 6. The blow molding step includes holding the neck portion 21 forming the opening of the preform 20 from the outer circumference by the neck mold 131, introducing blow air into the preform 20 by using the blow core 132, bending the preform 20 at a predetermined angle in a state in which the blow core 132 is inserted in the opening of the preform 20 while gripping the bottom portion 23 of the preform 20 by the rotation mechanism 134, and defining the blow cavity so as to accommodate the bent preform 20 by using the blow mold. The blow molding step of the present embodiment further includes bringing the stretch rod 133 disposed inside the blow core 132 into contact with the bottom portion 23 of the preform 20 and stretching the preform 20. Note that the preform in the bent state is referred to as a bent-neck preform 20′.

In the blow molding unit 130, the bent-neck container 10 is manufactured in a state in which the neck mold 131 that has transported the preform 20 is stationary and the blow core 132 is inserted in the opening of the preform 20. When the blow core 132 is inserted in the opening of the preform 20, a lower end portion 132a that is a distal end of the blow core 132 is disposed below the neck portion 21 and a bottom surface 131a of the neck mold 131. Subsequently, vertical axis stretching is applied on the preform 20 by lowering the stretch rod 133. After the bottom portion 23 (projecting portion 24) is engaged with the holding part 134a of the bottom mold part 135b, the stretch rod 133 is raised and returned to an initial position in the blow core 132. As illustrated in FIG. 5, when the holding part 134a is rotated along the guide portion 134b, the preform 20 is bent starting from the lower end portion 132a. A portion of the bent-neck preform 20′that is actually bent is referred to as a bent portion M. Therefore, the bent portion M is formed not in the body portion 22, immediately below the neck portion 21, but in the body portion 22, separated downward from the neck portion 21. The distance by which the bent portion M is separated from the neck portion 21 corresponds to the distance by which the blow core 132 protrudes downward from a lower end of the neck mold 131. Note that “immediately below the neck portion 21” indicates a portion slightly separated from the neck portion 21 toward the bottom portion 23 side. After formation of the bent-neck preform 20′, the pair of split molds 135a are closed to form the blow cavity. Next, blow air is introduced from the blow core 132 into the bent-neck preform 20′to apply lateral axis stretching (blow molding), shaping the bent-neck preform 20′into the bent-neck container 10.

FIG. 6 illustrates a central axis C passing through a central position of the bottom mold part 135b. In the present embodiment, at least part of the lower end portion 132a of the blow core 132 is disposed below the central axis C.

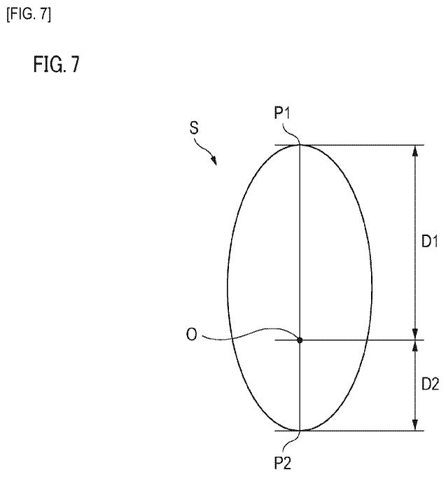

FIG. 7 is a sectional view of a cross section S taken from a direction of arrow VII in FIG. 6. The direction of arrow VII is aligned with the same line as the central axis C and is a direction in which the bottom mold part 135b is viewed from the neck mold 131. The cross section S indicates a cross section of the blow cavity passing through a center O of the lower end portion (opening portion) 132a of the blow core 132 and orthogonal to the central axis C. As illustrated in FIGS. 6 and 7, in the cross section S, an uppermost point P1 (longest distance from the center O to a blow cavity surface located on a valley side (bent side) of the bent-neck preform 20′) and a lowermost point P2 (longest distance from the center O to a blow cavity surface located on a peak side (opposite to bent side) of the bent-neck preform 20′) are determined. At this time, the blow core 132 is disposed such that a distance D1 from the uppermost point to the center is greater than a distance D2 from the lowermost point to the center.

### Comparative Example

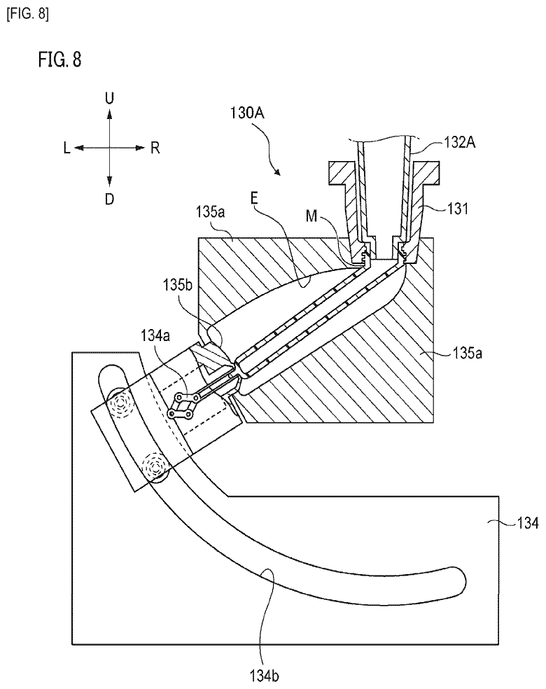

FIG. 8 illustrates a blow molding unit 130A according to a comparative example. In the blow molding unit 130A illustrated in FIG. 8, a lower end portion 132Aa of a blow core 132A is disposed at the same height as that of the bottom surface 131a of the neck mold 131 or further in the upward direction than the bottom surface 131a or at the same height as that of the neck portion 21. The preform 20 is bent in this state, and thus the preform 20 is bent starting from the neck mold 131. In other words, the bent portion M is formed in the body portion, immediately below the neck portion.

The neck portion of the preform 20 is thin as compared with the body portion and thus readily cools in the injection molding unit 110. Furthermore, the neck portion of the preform 20 is held by the neck mold 131 during molding, and thus heat of the neck portion is continuously absorbed. Therefore, the neck portion has a low temperature as compared with that of the body portion and is sufficiently solidified, resulting in high rigidity against bending. On the other hand, the body portion is adjusted in temperature to be in a hot, softened state, facilitating expansion by the blow air. A part of the body portion immediately below the neck mold 131 also has a higher temperature and relatively lower rigidity than the neck portion, and consequently readily bends. In particular, in a case in which the resin material of the preform 20 is polypropylene or polyethylene, the temperature suitable for blow molding is in a temperature range close to the melting point, and thus the neck portion and the body portion, immediately below the neck portion of the bent-neck preform 20′ transported to the blow molding unit, differ greatly in temperature and rigidity from each other. As a result, in the comparative example, when the holding part 134a is rotated, the preform 20 readily bends at the body portion, immediately below the neck mold 131. The blow core 132A merely has a function of providing a seal between the blow core 132A and the preform 20 so that blow air does not pass between the blow core 132A and the preform 20 during blow molding.

Here, on an outer surface of the bent portion M on the valley side of the bent-neck preform 20′, wrinkles (deep grooves having a horizontally elongated recessed shape) may occur due to the bending of the body portion. When the bent-neck preform 20′ with wrinkles is blow-molded, a bent-neck container with wrinkle portions or wrinkle traces (streak-like grooves) remaining on an outer surface may be manufactured.

In this regard, Patent Document 2 discloses that, by providing a constricted portion in the bent portion M that becomes the valley side in the preform 20, the material of the preform 20 gathers at the constricted portion, thereby mitigating the effect of the wrinkles. However, when blow molding is performed, the constricted portion itself may be reflected in the appearance of the bent-neck container.

The wrinkles of the preform 20 are considered to cause a poor appearance in the bent-neck container for the following reason. In the blow molding unit 130A of the comparative example, as illustrated in FIG. 8, the distance between the bent portion M of the bent-neck preform 20′ and an upper cavity surface E of the split molds 135a is short, reducing a blow ratio (stretch ratio) in the bent portion M. In other words, even when the bent-neck preform 20′ is blow-molded, the body portion, in the vicinity of the bent portion M, reaches the split molds 135a without substantially expanding. Therefore, the wrinkles generated in the bent portion M are cooled (solidified) by contact with the split molds 135a without being sufficiently extended, and substantially the same wrinkles or traces of wrinkles are reflected on the bent-neck container. Accordingly, the wrinkles are noticeable in the bent-neck container, deteriorating the appearance of the bent-neck container.

On the other hand, in the present embodiment, the bent portion M of the preform 20 is located below the neck mold 131 or the neck portion 21, and thus a distance DO until the bent portion M of the bent-neck preform 20′ reaches the upper cavity surface E of the split molds is increased, making it possible to increase the blow ratio at the bent portion M. Therefore, the blow core 132, which in the related art only had a function of introducing blow air into the preform 20 while securing airtightness, now has a function of defining a starting point for bending the preform 20.

According to the manufacturing apparatus 100 of the bent-neck container 10 having the configuration described above, the rotation mechanism 134 performs the operation of bending the preform 20 in a state in which the lower end portion 132a of the blow core 132 is disposed below the bottom surface 131a of the neck mold 131. As a result, the preform 20 readily bends starting from the lower end portion 132a of the blow core 132. This secures the distance DO from the bent portion M to the upper cavity surface E of the split molds 135a, making it possible to increase the blow ratio of the bent portion M. When the blow air is introduced in this state, the wrinkles formed in the bent-neck preform 20′are stretched (stretched by blow air) until the bent portion M is stretched and reaches the split molds 135a, making the effect of the wrinkles being formed less noticeable in the manufactured bent-neck container 10. Thus, the appearance of the bent-neck container 10 can be favorably improved.

According to the manufacturing method for manufacturing the bent-neck container 10 described above, the preform 20 is bent starting from the lower end portion 132a of the blow core 132. In other words, the blow core 132 has not only a function of introducing blow air into the bent-neck preform 20′, but also a function of defining the bent portion M of the preform 20. When the split molds 135a are closed, the distance DO from the bent portion M to the upper cavity surface E of the split mold 135a can be secured. Thus, the appearance of the bent-neck container 10 can be favorably improved.

In the manufacturing apparatus 100 for manufacturing the bent-neck container 10 and the manufacturing method for manufacturing the bent-neck container 10 according to the present embodiment, at least part of the lower end portion 132a of the blow core 132 is disposed below the central axis of the bottom mold part 135b. Therefore, the distance DO from the bent portion M of the preform 20 to the upper cavity surface E of the split molds 135a is longer.

In the manufacturing apparatus 100 for manufacturing the bent-neck container 10 and the manufacturing method for manufacturing the bent-neck container 10 according to the present embodiment, in the cross section S of the blow cavity orthogonal to the central axis of the bottom mold part 135b, the distance D1 from the uppermost point to the center of the lower end portion 132a is greater than the distance D2 from the lowermost point to the center of the lower end portion 132a. This increases the blow ratio at the bent portion M.

In the manufacturing apparatus 100 for manufacturing the bent-neck container 10 according to the present embodiment, the blow molding unit includes the stretch rod 133, and the manufacturing method includes stretching the preform 20 by using the stretch rod 133. When the preform is stretched by using the stretch rod, the body portion of the preform is stretched, reducing a thickness of a body wall of the preform. Therefore, a bending rigidity of the preform body portion is further reduced, and the preform readily bends at the body portion, immediately below the neck portion. As a result, in a case in which preliminary stretching is performed, the effect of the wrinkles being formed in the bent-neck container is easily apparent. However, according to the configuration described above, it is possible to suppress the bending of the preform 20 at the body portion 22, immediately below the neck portion 21.

### Second Embodiment

A manufacturing apparatus and a manufacturing method for manufacturing a bent-neck container according to a second embodiment will now be described. Note that members having the same reference signs as members already described in the description of embodiments will be omitted for convenience of description.

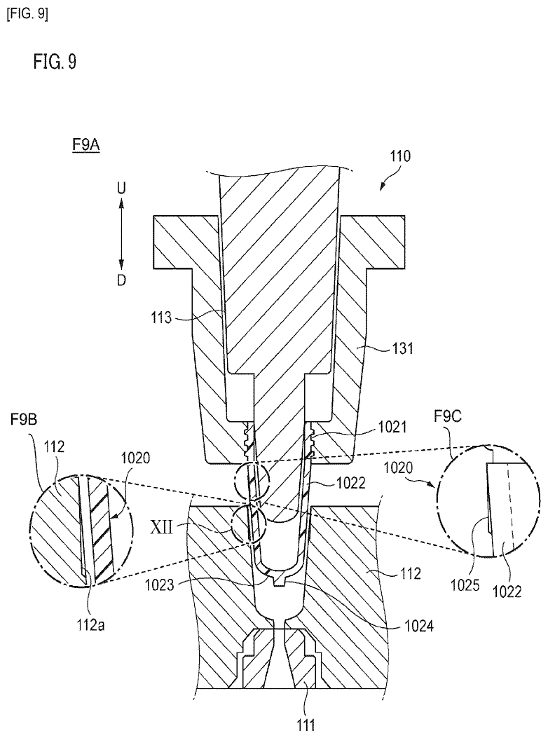

FIG. 9 illustrates the injection molding unit 110 according to the second embodiment. Note that F9A in FIG. 9 illustrates an overview of the injection molding unit 110. F9B in FIG. 9 illustrates an enlarged portion of the injection molding unit 110. F9C in FIG. 9 illustrates an enlarged portion of a preform 1020. As illustrated in FIG. 9, a body portion 1022 of the preform 1020 is formed so as to taper toward a bottom portion 1023.

In the preform 1020 according to the second embodiment, a thick portion 1025 is formed. The thick portion 1025 is formed so as to extend downward by a predetermined distance from the body portion 1022, immediately below the neck portion 1021. The preform 1020 of the present embodiment is configured such that an outer diameter of the body portion 1022 of the preform 1020 decreases from a neck portion 1021 toward the bottom portion 1023, even when the thick portion 1025 is formed. That is, the thick portion 1025 has a shape in which the bottom portion 1023 side of the preform 1020 protrudes more in an outer diameter direction than the neck portion 1021 side. The thick portion 1025 may be provided across the entire circumference of the preform 1020 in the circumferential direction, or may be provided across only a predetermined angular portion of the entire circumference of the preform 1020. The predetermined angular portion is, for example, a portion corresponding to an arc having a central angle of 90°. Further, the thick portion 1025 may be provided only in the body portion 1022, immediately below the neck portion 1021, on the side where the preform 1020 is bent. Further, the length of the thick portion 1025 is preferably set to a half or less, more preferably a quarter or less, of the length of the body portion 1022.

The injection molding unit 110 includes at least an injection molding mold (injection cavity mold) and an injection core mold. The injection molding mold and the injection core mold define, together with the neck mold 131, an injection cavity in the injection molding unit 110. The injection molding mold defines an injection cavity corresponding to outer wall surfaces of the body portion 1022 and the bottom portion 1023 of the preform 1020. An injection core defines an injection cavity corresponding to inner surfaces of the neck portion 1021, the body portion 1022, and the bottom portion 1023 of the preform 1020. The neck mold 131 defines an injection cavity corresponding to an outer wall surface of the neck portion 1021. Molten resin is injected from an injection device 111 toward the injection cavities, and the molten resin is cooled, thereby forming the preform 1020.

The injection molding mold is provided with a recessed portion 112a. The recessed portion 112a is provided extending downward by a predetermined distance from the injection molding mold that abuts against the neck mold 131. The recessed portion 112a is configured to define an injection cavity corresponding to the thick portion 1025 formed in the preform 1020. The injection molding mold 112 defines the injection cavity such that the outer diameter of the body portion 1022 of the preform 1020 decreases from the neck portion 1021 toward the bottom portion 1023. In other words, the injection molding mold is configured such that a cross-sectional area of a horizontal cross section of the injection cavity defined thereby decreases in the downward direction.

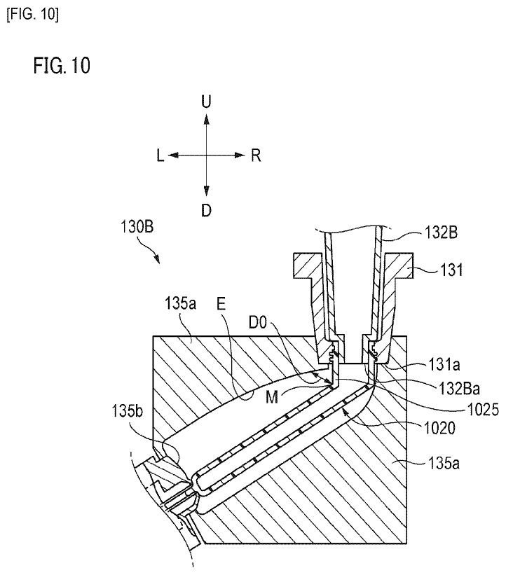

FIG. 10 illustrates a blow molding unit 130B according to the second embodiment. As in the first embodiment, the preform 1020 is bent by the rotation mechanism 134 into a bent-neck preform 1020′. The rotation mechanism 134 is configured to bend the preform 1020 in a direction in which the thick portion 1025 of the preform 1020 is provided. However, in a case in which the thick portion 1025 is provided across the entire circumference of the preform 1020 in the circumferential direction, bending in any direction is synonymous with bending the preform 1020 in the direction in which the thick portion 1025 is provided.

In the blow molding unit 130B according to the second embodiment, a lower end portion 132Ba of the blow core 132B is not disposed below the bottom surface 131a of the neck mold 131. However, as in the first embodiment, the preform 1020 is bent at the body portion 1022, away from the neck portion 1021, rather than immediately below the neck portion 1021.

In the present embodiment, the thick portion 1025 is provided in the body portion 1022, immediately below the neck portion 1021, where the resin material accumulates at the bent portion M due to bending deformation. The body portion 1022 provided with the thick portion 1025 has a higher bending rigidity than those of other parts of the body portion 1022. Accordingly, a most bendable portion of the preform 1020 is the body portion 1022, immediately below or below the thick portion 1025. Accordingly, the bent portion M is formed in the body portion 1022, immediately below the thick portion 1025. Note that “immediately below the thick portion 1025” indicates a portion slightly separated from the thick portion 1025 toward the bottom portion 1023 side.

When the split molds 135a are clamped against this bent-neck preform 1020′ to define the blow cavity, since the bent portion M is immediately below the thick portion 1025, the bent-neck preform 1020′ is accommodated in the blow cavity in a state in which the distance D0 from the bent portion M to the upper cavity surface E of the split molds 135a is secured.

According to the manufacturing apparatus and the manufacturing method for manufacturing a bent-neck container of the present embodiment, the injection molding mold is configured to form the thick portion 1025, and the rotation mechanism 134 bends the preform 1020 at the side where the thick portion 1025 is formed, making it possible to secure the distance D0 from the bent portion M to the upper cavity surface E of the split molds 135a.

In the manufacturing apparatus and the manufacturing method for manufacturing a bent-neck container according to the present embodiment, the injection molding mold defines the injection cavity such that the outer diameter of the body portion 1022 of the preform 1020 decreases from the neck portion 1021 toward the bottom portion 1023. Therefore, even when the thick portion 1025 is provided, the preform 1020 is formed in a tapered shape, facilitating release of the preform 1020 from the injection molding mold 112. The preform 1020 is less likely to rub against the injection molding mold 112 at the time of mold release, suppressing residual traces of rubbing against an outer wall surface of the preform 1020, and thus further improving the appearance of the bent-neck container.

Although embodiments of the disclosure have been described above, the technical scope of the disclosure, needless to say, should not be construed as being limited by the description of the embodiments. It should be understood by a person skilled in the art that the embodiments are merely examples, and that various modifications of the embodiments are possible within the scope of the invention described in the claims. The technical scope of the disclosure is determined on the basis of the scope of the invention described in the claims and equivalent scopes thereof.

For example, the shape of the thick portion is a triangular shape when viewed from a side surface of the preform in the embodiments, but is not limited to the shape of the disclosure. For example, the thick portion may have a curved surface in a side view of the preform.

Further, although the aspect illustrated in the first embodiment and the aspect illustrated in the second embodiment have been described independently of each other, a manufacturing apparatus and a manufacturing method for manufacturing a bent-neck container in which both aspects are adopted may be provided. That is, the manufacturing apparatus may be configured such that the preform provided with the thick portion is blow-molded by the blow molding unit in which the lower end portion of the blow core is disposed below the bottom surface of the neck mold.

The present application appropriately incorporates contents disclosed in JP 2022-177505 A filed on Nov. 4, 2022.

### Reference Signs List

10 Bent-neck container
11 Container mouth portion
11a Opening portion
12 Container body portion
13 Container bottom portion
13a Upper bottom portion
20, 1020 Preform
20′, 1020′ Bent-neck preform
21, 1021 Neck portion
22, 1022 Body portion
23, 1023 Bottom portion
24, 1024 Projecting portion
100 Manufacturing apparatus
110 Injection molding unit
111 Injection device
112 Injection molding mold
112a Recessed portion
120 Temperature adjustment unit
130, 130A, 130B Blow molding unit
131 Neck mold
131a Bottom surface
132, 132A, 132B Blow core
132a, 132Aa, 132Ba Lower end portion
133 Stretch rod
134 Rotation mechanism
134a Holding part
134b Guide portion
135a Split mold
135b Bottom mold part
140 Take-out unit
150 Transport means
1025 Thick portion
E Upper cavity surface
M Bent portion

1. A manufacturing apparatus for manufacturing a bent-neck container from a preform having a bottomed tubular shape by blow molding, the manufacturing apparatus comprising:
an injection molding unit configured to injection-mold the preform made of resin;
a blow molding unit configured to blow-mold the preform to manufacture the bent-neck container;
a neck mold configured to hold a neck portion forming an opening of the preform from an outer circumference of the neck portion; and
a transport mechanism configured to transport the neck mold from the injection molding unit to the blow molding unit, wherein
the blow molding unit includes
a blow core configured to introduce blow air into the preform,
a rotation mechanism configured to bend the preform at a predetermined angle while gripping a bottom portion of the preform in a state where the blow core is inserted in the opening of the preform, and
a blow mold configured to define a blow cavity to accommodate the preform that is bent, and
a lower end portion of the blow core is configured to be disposed below a bottom surface of the neck mold in a state where the blow core is inserted in the preform.

2. The manufacturing apparatus for manufacturing a bent-neck container according to claim 1, wherein
the blow mold includes a bottom mold part configured to define the blow cavity corresponding to a container bottom portion of the bent-neck container, and
the blow core is configured such that at least part of the lower end portion of the blow core is disposed below a central axis of the bottom mold part.

3. The manufacturing apparatus for manufacturing a bent-neck container according to claim 1, wherein
the blow molding unit further includes a stretch rod disposed inside the blow core and configured to come into contact with the bottom portion of the preform and stretch the preform.

4. A manufacturing apparatus for manufacturing a bent-neck container from a preform having a bottomed tubular shape by blow molding, the manufacturing apparatus comprising:
an injection molding unit configured to injection-mold the preform made of resin;
a blow molding unit configured to blow-mold the preform to manufacture the bent-neck container;
a neck mold configured to hold a neck portion forming an opening of the preform from an outer circumference of the neck portion; and
a transport mechanism configured to transport the neck mold from the injection molding unit to the blow molding unit, wherein
the blow molding unit includes
a rotation mechanism configured to grip a bottom portion of the preform and bend the preform at a predetermined angle, and
a blow mold configured to form a blow cavity to accommodate the preform that is bent,
the injection molding unit includes an injection molding mold configured to define an injection cavity in which the preform is formed,
the injection molding mold is configured to form, in a body portion of the preform in which a side surface of the bent-neck container is to be formed, a thick portion at a portion adjacent to the neck portion forming the opening of the preform, the thick portion being thicker than other parts of the body portion, and
the rotation mechanism is configured to bend the preform at a side where the thick portion is formed.

5. The manufacturing apparatus for manufacturing a bent-neck container according to claim 4, wherein
the injection molding mold is configured to define the injection cavity such that an outer diameter of the body portion of the preform provided with the thick portion decreases from the neck portion side toward the bottom portion side.

6. A manufacturing method for manufacturing a bent-neck container from a preform having a bottomed tubular shape by blow molding, the manufacturing method comprising:
an injection molding step of injection-molding the preform made of resin; and
a blow molding step of blow-molding the preform in a state where a neck portion forming an opening of the preform is held from an outer circumference by a neck mold to manufacture the bent-neck container, wherein
the blow molding step includes
introducing blow air into the preform, by using a blow core,
bending the preform at a predetermined angle in a state where the blow core is inserted in the opening of the preform while gripping a bottom portion of the preform, by using a rotation mechanism, and
defining a blow cavity to accommodate the preform that is bent, by using a blow mold, and the preform is bent by the rotation mechanism starting from a lower end portion of the blow core.

7. The manufacturing method for manufacturing a bent-neck container according to claim 6, wherein
the blow mold includes a bottom mold part configured to define a blow cavity corresponding to a container bottom portion of the bent-neck container, and
the blow core is inserted in the preform such that at least part of the lower end portion of the blow core is disposed below a central axis of the bottom mold part.

8. The manufacturing method for manufacturing a bent-neck container according to claim 6, wherein
the blow molding step further includes bringing a stretch rod disposed inside the blow core into contact with the bottom portion of the preform and stretching the preform.

9. A manufacturing method for manufacturing a bent-neck container from a preform having a bottomed tubular shape by blow molding, the manufacturing method comprising:
an injection molding step of injection-molding the preform made of resin; and
a blow molding step of blow-molding the preform in a state where a neck portion forming an opening of the preform is held from an outer circumference by a neck mold to manufacture the bent-neck container, wherein
the blow molding step includes
gripping a bottom portion of the preform and bending the preform at a predetermined angle, by using a rotation mechanism, and
defining a blow cavity to accommodate the preform that is bent, by using a blow mold,
the injection molding step includes defining an injection cavity in which the preform is formed, by using an injection molding mold,
the injection molding mold is configured to form, in a body portion of the preform in which a side surface of the bent-neck container is to be formed, a thick portion at a portion adjacent to the neck portion forming the opening of the preform, the thick portion being thicker than other parts of the body portion, and
the rotation mechanism is configured to bend the preform at a side where the thick portion is formed.

10. The manufacturing method for manufacturing a bent-neck container according to claim 9, wherein
the injection molding mold is configured to form the injection cavity such that an outer diameter of the body portion of the preform provided with the thick portion decreases from the neck portion side toward the bottom portion side.
